(19) United States
(12) Patent Application Publication
(10) Pub. No.: US 2019/0077401 A1
(43) Pub. Date: Mar. 14, 2019

(54) VEHICLE AND TRAVELING CONTROLLER

(71) Applicant: Panasonic Intellectual Property Management Co., Ltd., Osaka (JP)

(72) Inventor: YOSHINORI KATAGIRI, Kanagawa (JP)

(21) Appl. No.: 16/120,339

(22) Filed: Sep. 3, 2018

(30) Foreign Application Priority Data
Sep. 12, 2017 (JP) 2017-174744
Mar. 19, 2018 (JP) 2018-051364

(51) Int. Cl. B60W 30/10; B60W 10/20; B60W 10/18; G07C 5/08; B60W 10/04; H04W 4/44; H04W 4/46

(52) U.S. Cl. CPC B60W 30/10; B60W 10/20; B60W 10/18; G07C 5/0808; B60W 10/04; B60R 16/03; H04W 4/46; B60W 2710/18; B60W 2710/20; B60W 2550/00; H04W 4/44

(57) ABSTRACT

When a first traveling control circuit is in a prescribed state, the first traveling control circuit performs first traveling control, stops power supply to a second traveling control circuit, and supplies power to the second traveling control circuit for a second time period at intervals of a first time period. The second time period is shorter than the first time period. The second traveling control circuit that is supplied with the power outputs a state of the second traveling control circuit. When the first traveling control circuit is not in the prescribed state, the second traveling control circuit performs second traveling control.

The present application claims the benefit of foreign priorities of Japanese patent application 2017-174744 filed on Sep. 12, 2017 and Japanese patent application 2018-051364 filed on Mar. 19, 2018, the contents all of which are incorporated herein by reference.

### BACKGROUND

### 1. Technical Field

The present disclosure relates to a vehicle having a driving support function or an automatic driving function, and a traveling controller.

### 2. Background Art

In recent years, the development of vehicles mounted with an advanced driver assistance system (ADAS) and automatic driving vehicles has been accelerated. As the ADAS, emergency automatic braking, prevention of lane departure, monitoring of a blind spot, prevention of drowsy driving, and the like have been developed, for example. In order to realize the ADAS, it is requested that various sensors, such as a camera, a millimeter-wave radar, an infrared laser, or a sonar, be mounted onto a vehicle (refer to Unexamined Japanese Patent Publication No. 2015-055947, for example). In order to realize a high-function ADAS such as avoidance of collision with a pedestrian, it is requested that a camera be mounted and an image captured by the camera be analyzed. Image processing requires a large operation amount and large power consumption.

Hybrid vehicles (HEVs) and electrically driven vehicles (EVs) have been being developed in addition to the development of the ADAS and automatic driving. A large-capacity battery for traveling is mounted onto the HEVs and the EVs. Vehicles have been developed in which power of an integrated circuit (IC) for the ADAS or automatic driving is supplied from a battery for driving. As described above, the IC for the ADAS or automatic driving consumes a large amount of power to perform image processing. This power consumption significantly causes a decrease in capacity of the battery for traveling, which results in a decrease in a traveling distance.

### SUMMARY

The present disclosure provides a technique for suppressing an increase in power consumption while enhancing reliability of driving support or automatic driving.

A vehicle according to one aspect of the present disclosure includes a power unit, a steering unit, a braking unit, a first traveling control circuit, a second traveling control circuit, and an output circuit. The power unit can be electrically controlled. The steering unit can be electrically controlled. The braking unit can be electrically controlled. The first traveling control circuit can electrically control at least one of the power unit, the steering unit, and the braking unit, and can perform first traveling control. The second traveling control circuit can electrically control at least one of the power unit, the steering unit, and the braking unit, and can perform second traveling control. When the first traveling control circuit is in a prescribed state, the first traveling control circuit electrically controls at least one of the power unit, the steering unit, and the braking unit, performs the first traveling control, stops power supply to the second traveling control circuit, and supplies power to the second traveling control circuit for a second time period at intervals of a first time period. The second time period is shorter than the first time period. When the second traveling control circuit that is supplied with the power is not in a normal state, the output circuit outputs a prescribed output. When the first traveling control circuit is not in the prescribed state, the second traveling control circuit electrically controls at least one of the power unit, the steering unit, and the braking unit, and performs the second traveling control.

Any combinations of the components described above and modifications of the features of the present disclosure in methods, devices, systems, computer programs, and the like are still effective as other aspects of the present disclosure.

By employing the vehicle and the like according to the present disclosure, in driving support or automatic driving, normally, power is intermittently supplied to the second traveling control circuit for backup such that power consumption is suppressed from increasing. When power is supplied, whether the second traveling control circuit is in a normal state or in an abnormal state is confirmed. At least when the second traveling control circuit is in the abnormal state, the output circuit outputs the prescribed output. Therefore, abnormality of the second traveling control circuit can be recognized during a normal operation during which the first traveling control circuit may primarily operate, and reliability of driving support or automatic driving can be enhanced.

### BRIEF DESCRIPTION OF DRAWINGS

FIG. 1 is a block diagram illustrating a configuration of a vehicle according to a first exemplary embodiment of the present disclosure;

FIG. 2 illustrates an example of installation of sensors to be used for a first detection circuit and a second detection circuit;

FIG. 3 illustrates a specific example of a retreating function of a first stop control circuit;

FIG. 4 illustrates a specific example of a retreating function of a second stop control circuit;

FIG. 5 is a diagram in which a speed and an absolute value of acceleration while decelerating of a vehicle in first stop control illustrated in FIG. 3 are compared with a speed and an absolute value of acceleration while decelerating of a vehicle in second stop control illustrated in FIG. 4;

FIG. 6A is a diagram for describing user interface (UI) circuit 80 according to the first exemplary embodiment of the present disclosure;

FIG. 6B is a diagram for describing UI circuit 80 according to the first exemplary embodiment of the present disclosure;

FIG. 6C is a diagram for describing UI circuit 80 according to the first exemplary embodiment of the present disclosure;

FIG. 6D is a diagram for describing UI circuit 80 according to the first exemplary embodiment of the present disclosure;

FIG. 7 is a flowchart illustrating specific processing for managing power supply to the first stop control circuit and the second stop control circuit that is performed by a diagnostic circuit; and

FIG. 8 is a block diagram illustrating a configuration of a vehicle according to a second exemplary embodiment of the present disclosure.

### DETAILED DESCRIPTION OF PREFERRED EMBODIMENTS

Prior to description of exemplary embodiments of the present disclosure, a problem concerning a conventional technique will be briefly described. It is requested that a control system that is directly connected to safety, such as emergency automatic braking, be made redundant so as to have reliability improved. However, redundancy results in a further increase in power consumption.

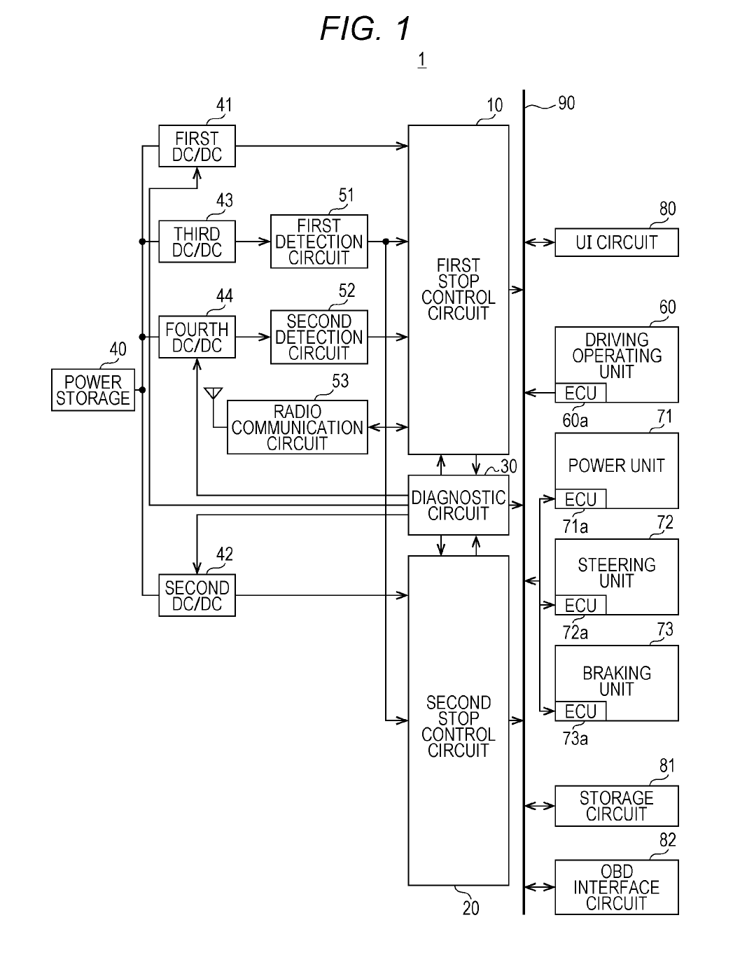

FIG. 1 is a block diagram illustrating a configuration of vehicle 1 according to a first exemplary embodiment of the present disclosure. Vehicle 1 according to the first exemplary embodiment is an HEV or an EV, and is an ADAS vehicle having an automatic stop function for avoiding collision. Vehicle 1 includes power unit 71, steering unit 72, braking unit 73, driving operating unit 60, power storage 40, first direct current (DC)/DC converter 41, second DC/DC converter 42, third DC/DC converter 43, fourth DC/DC converter 44, first detection circuit 51, second detection circuit 52, radio communication circuit 53, first stop control circuit 10, second stop control circuit 20, diagnostic circuit 30, and in-vehicle network 90.

Power unit 71 is a general name for a member that accelerates vehicle 1, and includes an inverter, a motor for traveling, a transmission, a power system electronic control unit (ECU) 71a, and the like. In a case where vehicle 1 is an HEV, power unit 71 also includes an engine. Steering unit 72 is a general name for a member that causes vehicle 1 to take a curve, and includes a power steering, steering system ECU 72a, and the like. Braking unit 73 is a general name for a member that decelerates or stops vehicle 1, and includes a brake (a hydraulic brake/a regeneration brake/a regenerative cooperative brake), an antilock brake system (ABS), braking system ECU 73a, and the like.

Each of power system ECU 71a, steering system ECU 72a, and braking system ECU 73a is connected to in-vehicle network 90. In-vehicle network 90 is a network with a gateway function, and is structured by using at least one of standards such as controller area network (CAN), local interconnect network (LIN), FlexRay (registered trademark), or Ethernet (registered trademark). Power system ECU 71a, steering system ECU 72a, and braking system ECU 73a are connected to a main network of in-vehicle network 90. In the present exemplary embodiment, an example is assumed in which CAN is used for the main network.

Driving operating unit 60 is a general name for a member that is used by a driver to operate vehicle 1. Driving operating unit 60 includes an accelerator pedal, a steering wheel, a brake pedal, a turn-signal switch, operation system ECU 60a, and the like. Operation system ECU 60a converts an operation performed on the accelerator pedal by the driver into an electrical control signal, and transmits the control signal to at least one of power system ECU 71a, steering system ECU 72a, and braking system ECU 73a via in-vehicle network 90. Power system ECU 71a, steering system ECU 72a, or braking system ECU 73a controls a corresponding actuator in accordance with the received control signal.

Driving operating unit 60 is also connected to various indicator lamps such as turn signals, brake lamps, or hazard lamps, although these are not illustrated. The various indicator lamps flash on or off in accordance with the operation of the driver.

Power storage 40 is a power source in the vehicle, and includes a lithium ion storage battery, a nickel hydrogen storage battery, a lead storage battery, an electric double-layer capacitor, a lithium ion capacitor, and the like. In the present exemplary embodiment, an example is assumed in which the lithium ion storage battery is used. Power storage 40 of FIG. 1 is assumed to be a traction battery that is installed separately from an auxiliary battery (normally, a 12 V output lead storage battery is used). The traction battery is mounted while primarily aiming at supplying power to the motor for traveling via the inverter. In the present exemplary embodiment, a system configuration is employed in which power supply of first stop control circuit 10 and second stop control circuit 20 that consume a large amount of power is obtained from the traction battery.

In FIG. 1, a power supply route between power storage 40 and power unit 71, and the auxiliary battery are omitted in order to simplify the drawing. A system configuration may be employed in which the auxiliary battery is not provided and power is supplied from power storage 40 to all of the electric components in the vehicle.

In a case where a large motor for traveling is used, a traction battery that outputs 200 V or more is used. In a case where a small motor for traveling is used, a traction battery that outputs less than 100 V is used. The small motor for traveling is used in mild hybrid vehicles or micro EVs. As an example, a vehicle mounted with a 48 V output lithium ion storage battery has been put into practice.

First detection circuit 51 is a general name for various sensors that grasp a situation around a self-vehicle and a state of the self-vehicle. As a sensor that grasps the situation around the self-vehicle, at least one of a visible light camera (monocular/compound-eye), an infrared radar, a millimeter-wave radar, and a sonar is included. The visible light camera captures a video of an outside of the vehicle, and outputs the video to first stop control circuit 10 and second stop control circuit 20. In a case where a compound-eye camera is used, a distance from the vehicle to an object can be estimated on the basis of a parallax video. In a camera system, pedestrians can be detected in the video, and collision with the pedestrians in addition to another vehicle can be avoided.

The infrared radar emits infrared laser around vehicle 1, obtains a reflected signal from an object (such as a front vehicle), and outputs the reflected signal to first stop control circuit 10 and second stop control circuit 20. The millimeter-wave radar emits millimeter waves around vehicle 1, obtains a reflected signal from an object, and outputs the reflected signal to first stop control circuit 10 and second stop control circuit 20. The millimeter-wave radar can detect an object that is located farther than the infrared laser. In an infrared radar system and a millimeter-wave radar system, it is difficult to detect pedestrians.

The sonar emits ultrasonic waves around vehicle 1, obtains a reflected signal from an object, and outputs the reflected signal to first stop control circuit 10 and second stop control circuit 20. The sonar is suitable for detection of an object that is located at a short distance, and can detect pedestrians.

As the sensor that grasps the situation around the self-vehicle, a light detection and ranging (LIDAR) may be used. The LIDAR is an expensive sensor. However, in a case where vehicle 1 is an automatic driving vehicle and first stop control circuit 10 is implemented as some functions of automatic driving, it is easy to mount the LIDAR in terms of cost.

As the sensor that grasps the situation around the self-vehicle, a vehicle speed sensor, a global positioning system (GPS), and the like are included. The vehicle speed sensor detects a speed of vehicle 1. The GPS sensor detects positional information about vehicle 1. Specifically, the GPS sensor receives respective transmission times from a plurality of GPS satellites, and calculates latitude and longitude of a reception point based on the received transmission times.

Second detection circuit 52 detects a situation inside a vehicle compartment. Second detection circuit 52 includes a sensor that monitors a state of a driver (for example, a state of eyes of the driver). As the sensor, the visible light camera or the infrared camera can be used. In a case where the infrared camera is used, when the eyes of the driver are imaged in a state where weak infrared rays are emitted to the eyes of the driver, detection accuracy is improved. Second detection circuit 52 outputs a video captured by the visible light camera or the infrared camera to first stop control circuit 10. As the sensor that monitors the state of the driver, a seating sensor and the like may be used in addition to the camera.

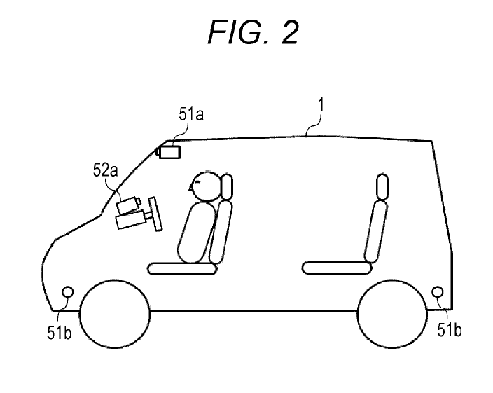

FIG. 2 illustrates an example of installation of sensors to be used for first detection circuit 51 and second detection circuit 52. In FIG. 2, camera 51a, which is one example of first detection circuit 51, is installed on a windshield rearview mirror inside vehicle 1, and photographs a front side in a traveling direction of vehicle 1. Camera 51a may be installed in a plurality of positions of vehicle 1. Camera 51a may be installed outside vehicle 1. As an example, camera 51a may be incorporated into a front grille.

In FIG. 2, sonar 51b, which is one example of first detection circuit 51, is installed in a plurality of positions of vehicle 1. Specifically, sonars 51b are respectively installed inside holes that are formed on a front bumper and a rear bumper. The sonars are installed similarly on the opposite side.

In FIG. 2, camera 52a, which is one example of second detection circuit 52, is installed on a steering fixing part. Camera 52a may be installed in any position inside the vehicle where the eyes of the driver can be detected.

Return now to the description of FIG. 1. Radio communication circuit 53 performs radio communication with an external control center, an external data center, a road-side device, another vehicle, and the like. As an example, a mobile telephone network (a cellular network), a wireless local area network (LAN), an electronic toll collection system (ETC), dedicated short range communications (DSRC), a vehicle-to-infrastructure (V2I), and a vehicle-to-vehicle (V2V) can be used.

In the present exemplary embodiment, power of first stop control circuit 10, second stop control circuit 20, first detection circuit 51, and second detection circuit 52 is supplied from power storage 40. First DC/DC converter 41 is interposed between power storage 40 and first stop control circuit 10. First DC/DC converter 41 insulates power storage 40 from first stop control circuit 10, and steps down a voltage (for example, 48 V) of power storage 40 to a prescribed control voltage (for example, 9 V to 14 V). The stepped-down control voltage is supplied to first stop control circuit 10. First stop control circuit 10 includes a step-down circuit such as a switching regulator, and the step-down circuit steps down the supplied control voltage (for example, 9 V to 14 V) to a power supply voltage (for example, 3 V to 5 V) of first stop control circuit 10.

Second DC/DC converter 42 is interposed between power storage 40 and second stop control circuit 20. Second DC/DC converter 42 insulates power storage 40 from second stop control circuit 20, and steps down the voltage of power storage 40 to the prescribed control voltage. The stepped-down control voltage is supplied to second stop control circuit 20. Second stop control circuit 20 includes a step-down circuit, and the step-down circuit steps down the supplied control voltage to a power supply voltage of second stop control circuit 20.

Third DC/DC converter 43 is interposed between power storage 40 and first detection circuit 51. Third DC/DC converter 43 insulates power storage 40 from first detection circuit 51, and steps down the voltage of power storage 40 to the prescribed control voltage. The stepped-down control voltage is supplied to each of the sensors of first detection circuit 51, is adjusted according to an operating voltage of each of the sensors, and is used.

Fourth DC/DC converter 44 is interposed between power storage 40 and second detection circuit 52. Fourth DC/DC converter 44 insulates power storage 40 from second detection circuit 52, and steps down the voltage of power storage 40 to the prescribed control voltage. The stepped-down control voltage is supplied to each of the sensors of second detection circuit 52, is adjusted according to an operating voltage of each of the sensors, and is used. Fourth DC/DC converter 44 can be omitted. In this case, the control voltage is input from third DC/DC converter 43 to the sensors of second detection circuit 52.

First detection circuit 51 and second detection circuit 52 may be configured to receive power supply from a not-illustrated auxiliary battery rather than power storage 40. In this case, third DC/DC converter 43 and fourth DC/DC converter 44 are omitted.

In FIG. 1, a power supply route of diagnostic circuit 30 is not illustrated, but diagnostic circuit 30 may be configured to receive supply of the prescribed control voltage from third DC/DC converter 43, or may be configured to receive power supply from the auxiliary battery. It is preferable that the power supply route of diagnostic circuit 30 be made redundant. As the control voltage, 20 V to 25 V may be used.

First stop control circuit 10 is a circuit that performs first stop control on vehicle 1, and is implemented by cooperation between hardware resources and software resources, or by only the hardware resources. As the hardware resources, a central processing unit (CPU), a graphics processing unit (GPU), a digital signal processor (DSP), a field-programmable gate array (FPGA), a read-only memory (ROM), a random-access memory (RAM), and another large-scale integration (LSI) can be used. As the software resources, programs such as an operating system, an application, or firmware can be used. First stop control circuit 10 may be implemented so as to be integrated into an automatic driving controller.

First stop control circuit 10 receives detection information detected by first detection circuit 51 and detection information detected by second detection circuit 52. When first stop control circuit 10 determines that vehicle 1 has a risk of collision with an obstacle, first stop control circuit 10 outputs a control signal that causes stop control to be performed to at least one of power unit 71, steering unit 72, and braking unit 73. As the stop control, vehicle 1 is stopped in an emergency regardless of an operation of the driver. First stop control circuit 10 has a retreating function of causing vehicle 1 to retreat to a safety zone such as a road shoulder or an emergency parking strip when vehicle 1 is stopped in an emergency.

When first stop control circuit 10 determines that there is a risk of collision with an obstacle such as another vehicle, a pedestrian, a bicycle, a wall, or a guardrail on the basis of the detection information detected by first detection circuit 51, first stop control circuit 10 transmits a control signal that instructs an emergency stop to braking system ECU 73a. When the retreating function is activated, first stop control circuit 10 determines a stop position having a high safely of vehicle 1.

First stop control circuit 10 determines the stop position on the basis of a current position of vehicle 1 that has been obtained from the GPS sensor and map data indicating an area near the current position. First stop control circuit 10 may obtain the map data indicating the area near the current position by cooperating with a car navigation system, or may obtain the map data via radio communication circuit 53.

First stop control circuit 10 specifies, from a peripheral area of vehicle 1, a stop position that is located near the current position and where vehicle 1 will not protrude or will barely protrude. First stop control circuit 10 obtains a situation of the specified stop position from first detection circuit 51. When no obstacles exist near the specified stop position, first stop control circuit 10 determines the stop position to be a formal stop position. When an obstacle exists near the specified stop position, first stop control circuit 10 performs processing for selecting the stop position again.

When first stop control circuit 10 determines the stop position, first stop control circuit 10 transmits a control signal that causes vehicle 1 to move to the stop position to power system ECU 71a and steering system ECU 72a. When vehicle 1 arrives at the stop position, first stop control circuit 10 transmits, to braking system ECU 73a, a control signal instructing a stop.

When first stop control circuit 10 determines that an abnormality has occurred in the driver on the basis of the detection information detected by second detection circuit 52, first stop control circuit 10 stops vehicle 1 in an emergency. Specific control performed at the time of an emergency stop is similar to the above-described processing at the time of avoidance of collision.

First stop control circuit 10 obtains the video from camera 52a, and specifies a face of the driver in the video by using a face identifying device. When the eyes of the driver are closed during a prescribed time period or longer, first stop control circuit 10 determines that the driver is dozing, and stops vehicle 1 in an emergency.

A driver who is driving a vehicle may suffer a sudden illness such as myocardial infarction or cerebral infarction. As an example, when a line of sight of the driver deviates from a forward direction during a prescribed time period or longer, when a movement of the line of sight of the driver is abnormal, or when the eyes of the driver fail to be detected in the video during a prescribed time period or longer, first stop control circuit 10 determines that the sudden illness has occurred, and stops vehicle 1 in an emergency.

A position of a line of sight can be specified, for example, as described below. In a case where the visible light camera is used, first stop control circuit 10 sets an inner corner of the driver's eye to be a reference point and sets an iris to be a moving point in a visible light image, and specifies the position of the line of sight in accordance with a positional relationship between the reference point and the moving point. In a case where the infrared camera is used, first stop control circuit 10 sets a corneal reflex to be a reference point and sets a pupil to be a moving point in an infrared image, and specifies the position of the line of sight in accordance with a positional relationship between the reference point and the moving point.

When first stop control circuit 10 determines that the driver has suffered the sudden illness, first stop control circuit 10 transmits a radio signal reporting that the sudden illness has occurred to an information terminal device of the control center via radio communication circuit 53. At this time, first stop control circuit 10 may simultaneously transmit video data of the driver at the time of the determination of the occurrence of the sudden illness.

A person in charge in the control center performs the arrangement of an ambulance and a hospital. The person in change may transfer the received video data to an information terminal device of the ambulance or the hospital. The radio signal reporting that the sudden illness has occurred may be directly transmitted from vehicle 1 to an information terminal device of a firehouse or a police station.

Second stop control circuit 20 is a backup circuit of first stop control circuit 10. Second stop control circuit 20 is also implemented by cooperation between hardware resources and software resources, or by only the hardware resources. Each of first stop control circuit 10 and second stop control circuit 20 is configured by independent hardware.

In the present exemplary embodiment, second stop control circuit 20 has a simpler configuration than first stop control circuit 10. Specifically, a scale of first stop control circuit 10 is configured to be larger than a scale of second stop control circuit 20. A scale of a circuit can be expressed, for example, by a number of transistors or an area of a semiconductor chip in a case where the same microfabrication technique is applied.

The detection information detected by first detection circuit 51 is input to second stop control circuit 20, but the detection information detected by second detection circuit 52 is not input to second stop control circuit 20. Stated another way, second stop control circuit 20 does not have a function of monitoring the driver and stopping vehicle 1 in an emergency when an abnormality has occurred in the driver. In addition, second stop control circuit 20 does not have a function of transmitting, to an outside, a radio signal reporting that the driver has suffered a sudden illness.

Second stop control circuit 20 has a retreating function that is simpler than the retreating function of first stop control circuit 10. Specifically, the retreating function of second stop control circuit 20 does not have a function of determining a stop position on the basis of a current position of vehicle 1 that has been obtained from the GPS sensor and map data indicating an area near the current position. The retreating function of second stop control circuit 20 is basically a function of only pulling over vehicle 1 to a road shoulder and stopping vehicle 1. Stated another way, in first stop control performed by first stop control circuit 10, a first route is obtained on the basis of positional information of vehicle 1, and stop control is performed along the first route. In contrast, in second stop control performed by second stop control circuit 20, a second route is obtained without using the positional information of vehicle 1, and stop control is performed along the second route.

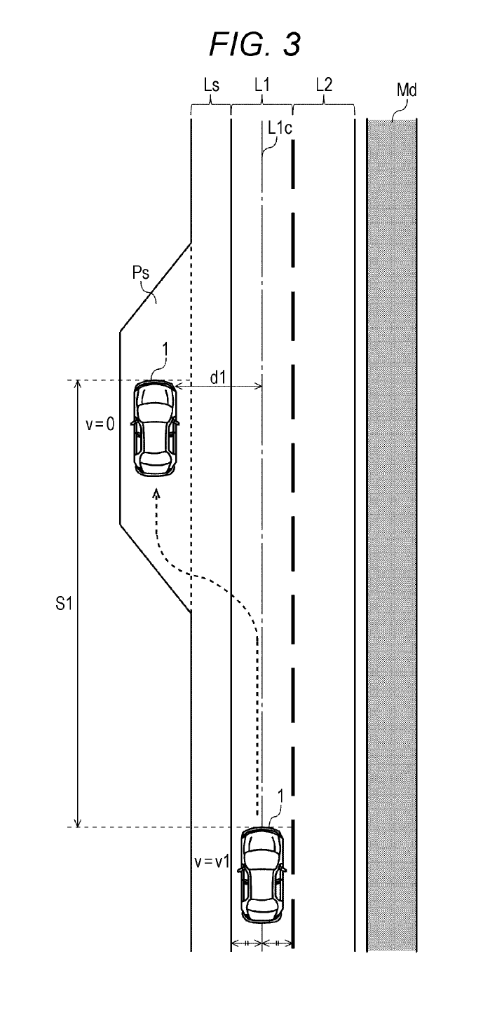

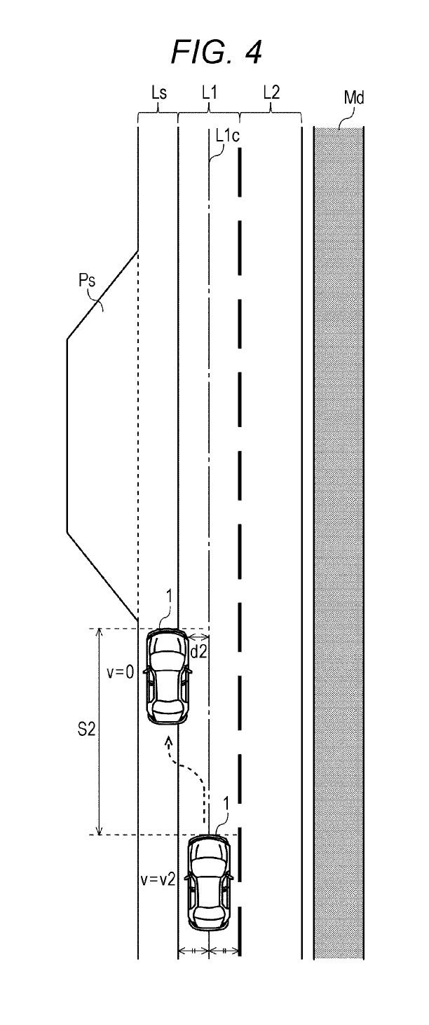

FIG. 3 illustrates a specific example of the retreating function of first stop control circuit 10. FIG. 4 illustrates a specific example of the retreating function of second stop control circuit 20. FIGS. 3 and 4 illustrate an example of a road having two lanes (first lane L1, second lane L2) on each side across medial strip Md. Emergency parking strip Ps is provided in a portion of road shoulder Ls adjacent to first lane L1. Vehicle 1 is traveling on first lane L1.

In first stop control performed by first stop control circuit 10, when emergency parking strip Ps exists within a range of a prescribed distance from vehicle 1, vehicle 1 is controlled to stop in emergence parking strip Ps. In contrast, in second stop control performed by second stop control circuit 20, vehicle 1 is always controlled to stop in road shoulder Ls that is close to vehicle 1.

In FIG. 3, a stop position in first stop control performed by first stop control circuit 10 is located apart from first lane L1 by first distance d1. First distance d1 is defined by a distance from center line L1c of first lane L1 to an end on a side of center line L1c of vehicle 1. In FIG. 4, a stop position in second stop control performed by second stop control circuit 20 is located apart from first lane L1 by second distance d2. Second distance d2 is defined similarly by the distance from center line L1c of first lane L1 to the end on the side of center line L1c of vehicle 1. As illustrated in FIGS. 3 and 4, first distance d1 is longer than second distance d2.

As illustrated in FIGS. 3 and 4, stop distance S1 in first stop control performed by first stop control circuit 10 is longer than stop distance S2 in second stop control performed by second stop control circuit 20. An absolute value of acceleration while decelerating in first stop control performed by first stop control circuit 10 is smaller than an absolute value of acceleration while decelerating in second stop control performed by second stop control circuit 20.

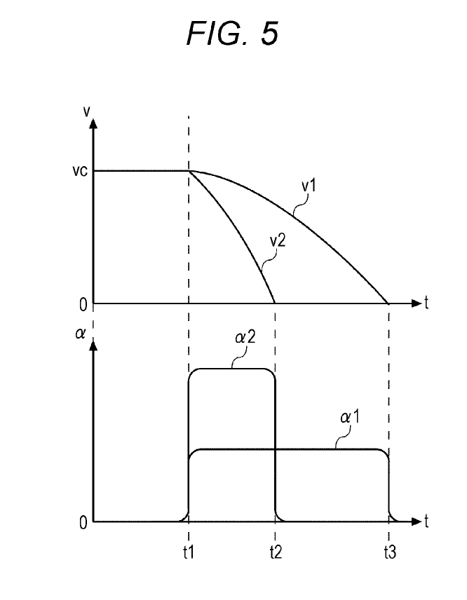

FIG. 5 is a diagram in which a speed and an absolute value of acceleration while decelerating of vehicle 1 in the first stop control illustrated in FIG. 3 are compared with a speed and an absolute value of acceleration while decelerating of vehicle 1 in the second stop control illustrated in FIG. 4.

First time t1 is a timing at which a phenomenon that causes an emergency stop has occurred, and is a timing at which vehicle 1 starts deceleration in first stop control or second stop control. In first stop control, vehicle 1 is decelerated at first speed V1, and in second stop control, vehicle 1 is decelerated at second speed V2. Second time t2 is a timing at which vehicle 1 stops in second stop control, and third time t3 is a timing at which vehicle 1 stops in first stop control. Absolute value of acceleration while decelerating α1 in first stop control is smaller than absolute value of acceleration while decelerating α2 in second stop control.

Return now to the description of FIG. 1. Diagnostic circuit 30 diagnoses states of first stop control circuit 10 and second stop control circuit 20, and manages power supply to first stop control circuit 10 and second stop control circuit 20. Diagnostic circuit 30 is also implemented by cooperation between hardware resources and software resources, or by only the hardware resources. Diagnostic circuit 30 is configured by a chip that is different from a chip of first stop control circuit 10. Diagnostic circuit 30 and second stop control circuit 20 may be integrated into a single chip, or may be configured by chips different from each other.

A first state signal indicating normality or abnormality is input from first stop control circuit 10 to diagnostic circuit 30. The first state signal is input, for example, as a pulse signal. It is preferable that a route through which the first state signal is transmitted be made redundant by a plurality of routes. First stop control circuit 10 constantly outputs the first state signal to diagnostic circuit 30.

When first stop control circuit 10 is in a normal state, diagnostic circuit 30 controls second stop control circuit 20 to intermittently operate. When first stop control circuit 10 is in the normal state, diagnostic circuit 30 basically stops an operation of second stop control circuit 20, supplies power to second stop control circuit 20 at intervals of a first time period during a second time period that is shorter than the first time period, and diagnoses a state of second stop control circuit 20. When power is supplied to second stop control circuit 20, second stop control circuit 20 outputs, to diagnostic circuit 30, a second state signal indicating normality or abnormality of second stop control circuit 20 itself.

When diagnostic circuit 30 stops the operation of second stop control circuit 20, diagnostic circuit 30 may set power supply to second stop control circuit 20 in an OFF state, in a sleep state, or in a pause state. In the present exemplary embodiment, an example is assumed in which second DC/DC converter 42 that supplies power to second stop control circuit 20 is stopped such that power supply to second stop control circuit 20 is set in the OFF state.

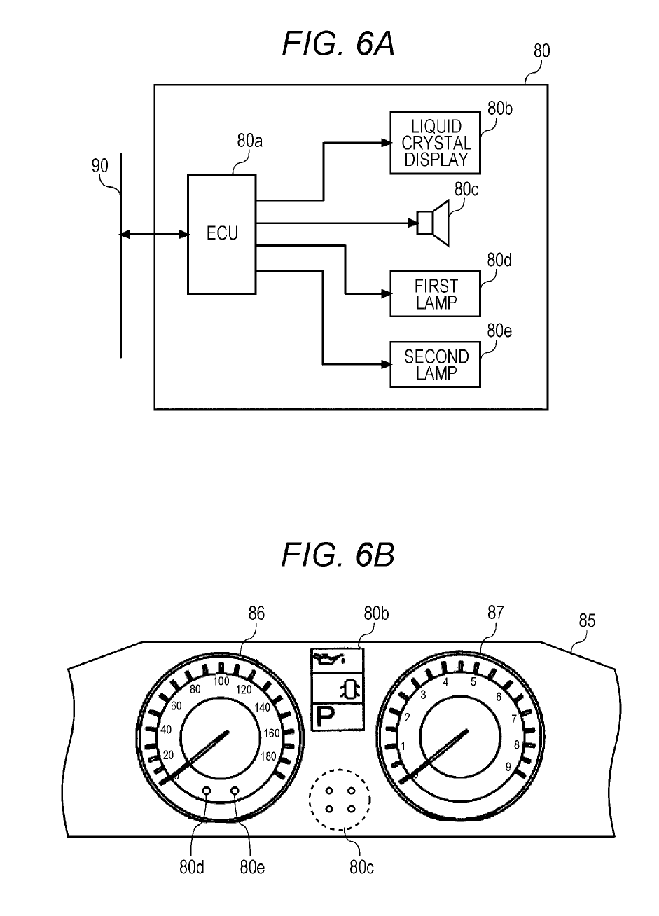

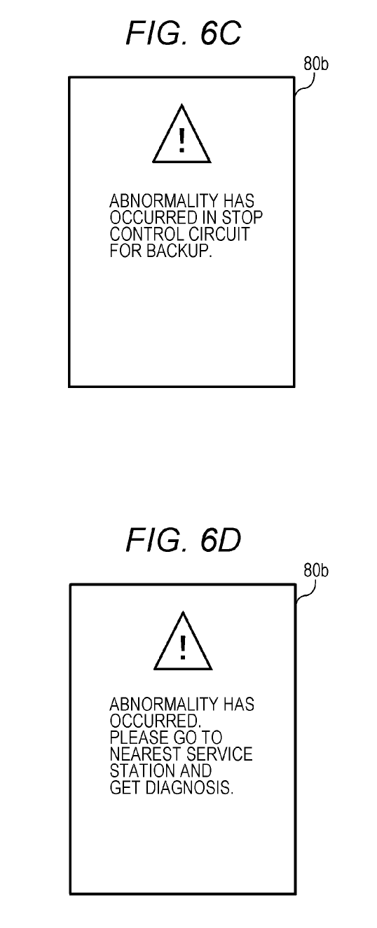

FIGS. 6A to 6D are diagrams for describing user interface (UI) circuit 80. FIG. 6A illustrates a block diagram of UI circuit 80, and the like. ECU 80a performs communication with in-vehicle network 90, and controls blocks in UI circuit 80. Liquid crystal display 80b has a prescribed shape, for example, a rectangular shape, and conducts a prescribed display according to an instruction of ECU 80a. Speaker 80c outputs a prescribed sound message according to an instruction of ECU 80a. First lamp 80d flashes on or off according to an instruction of ECU 80a. Similarly to first lamp 80d, second lamp 80e flashes on or off according to an instruction of ECU 80a. FIG. 6B illustrates the arrangement of liquid crystal display 80b, speaker 80c, first lamp 80d, and second lamp 80e in instrument panel 85. Liquid crystal display 80b is disposed between speed meter 86 indicating a speed of vehicle 1 and tachometer 87 indicating a number of revolutions of an engine (not illustrated) mounted onto vehicle 1, and has a vertically elongated rectangular shape. Liquid crystal display 80b can be considered to be disposed on instrument panel 85 and be disposed near speed meter 86. Speaker 80c is disposed inside instrument panel 85, and outputs a sound message via a hole. First lamp 80d and second lamp 80e are disposed inside an outer edge (a circular shape) of speed meter 86. FIGS. 6C and 6D illustrate a display example of liquid crystal display 80b.

Instrument panel 85 is disposed so as to face the driver serving as one example of a passenger of vehicle 1, and the driver can recognize at least a display content of liquid crystal display 80b, flashing on or off of first lamp 80d, and flashing on or off of second lamp 80e. Similarly, the driver can hear sound emitted from speaker 80c.

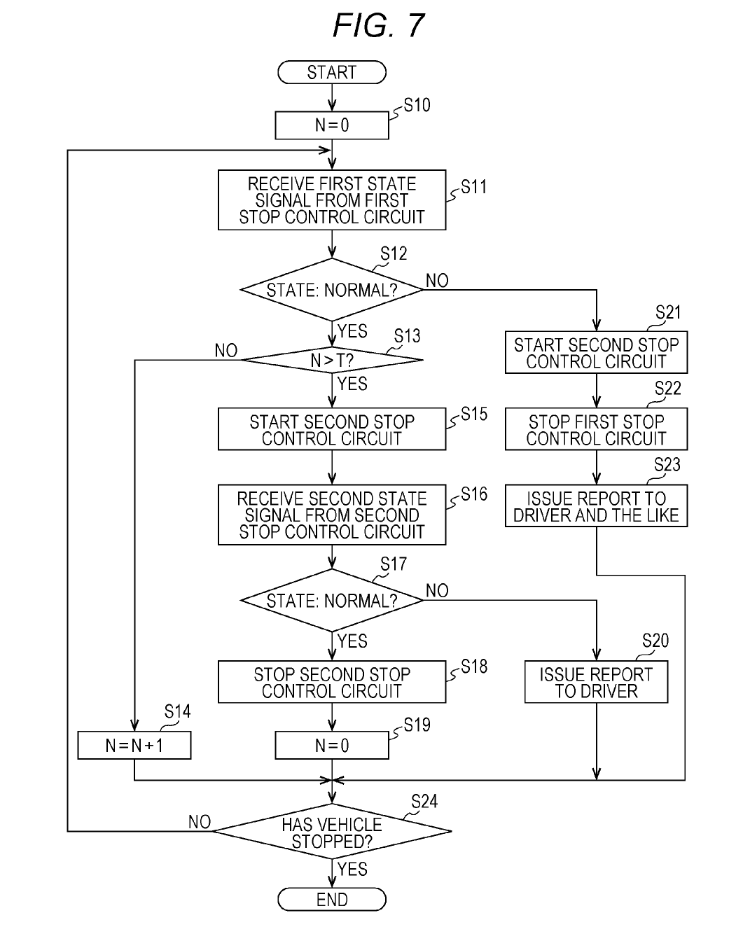

FIG. 7 is a flowchart illustrating specific processing for managing power supply to first stop control circuit 10 and second stop control circuit 20 that is performed by diagnostic circuit 30. Diagnostic circuit 30 sets parameter N to zero as initial value setting (S10). Diagnostic circuit 30 receives the first state signal from first stop control circuit 10 (S11).

Diagnostic circuit 30 determines whether a state of first stop control circuit 10 is normal or abnormal on the basis of the received first state signal (S12). When the state of first stop control circuit 10 is normal (YES in S12), diagnostic circuit 30 determines whether parameter N exceeds setting value T (S13). A case where the state of first stop control circuit 10 is normal (YES in S12) can be regarded as a prescribed state. Setting value T is a parameter that defines a wake-up interval of second stop control circuit 20, and is set by a designer. When parameter N is less than or equal to setting value T (NO in S13), diagnostic circuit 30 increments parameter N (S14). When parameter N exceeds setting value T (YES in S13), diagnostic circuit 30 transmits an operation signal (an ON signal) to second DC/DC converter 42 and second stop control circuit 20, and starts second stop control circuit 20 (S15). When second stop control circuit 20 is started, second stop control circuit 20 transmits the second state signal to diagnostic circuit 30 (S16).

Diagnostic circuit 30 determines whether a state of second stop control circuit 20 is normal or abnormal on the basis of the received second state signal (S17). When the state of second stop control circuit 20 is normal (YES in S17), diagnostic circuit 30 transmits a stop signal (an OFF signal) to second DC/DC converter 42 and second stop control circuit 20, and stops second stop control circuit 20 (S18). Diagnostic circuit 30 resets parameter N to zero (S19).

When the state of second stop control circuit 20 is abnormal (NO in S17), diagnostic circuit 30 reports abnormality of second stop control circuit 20 to the driver (S20). As an example, diagnostic circuit 30 causes first lamp 80d provided in UI circuit 80 to flash such that first lamp 80d indicates that the state of second stop control circuit 20 is abnormal. Alternatively, diagnostic circuit 30 may cause second lamp 80e to flash such that second lamp 80e reports that some kind of abnormality has occurred and recommends that a prescribed diagnosis be gotten. Diagnostic circuit 30 may display, on liquid crystal display 80b provided in UI circuit 80, that the state of second stop control circuit 20 is abnormal. As an example, diagnostic circuit 30 may display the message “Abnormality has occurred in stop control circuit for backup.”, as illustrated in FIG. 6C.

Alternatively, diagnostic circuit 30 may conduct a display reporting that some kind of abnormality has occurred and recommending that a diagnosis be gotten. As an example, diagnostic circuit 30 may display the message “Abnormality has occurred. Please go to nearest service station and get diagnosis.”, as illustrated in FIG. 6D. Diagnostic circuit 30 may cause speaker 80c provided in UI circuit 80 to output a sound message indicating that the state of second stop control circuit 20 is abnormal (for example, “Abnormality has occurred in stop control circuit for backup.”), or a sound message reporting that some kind of abnormality has occurred and recommending that a prescribed diagnosis be gotten (for example, “Abnormality has occurred. Please go to nearest service station and get diagnosis.”).

When the state of second stop control circuit 20 is abnormal (NO in S17), diagnostic circuit 30 may transmit information indicating that the state of second stop control circuit 20 is abnormal to the external control center, the external data center, the road-side device, another vehicle, or the like via first stop control circuit 10 and radio communication circuit 53.

When the state of second stop control circuit 20 is abnormal (NO in S17), diagnostic circuit 30 may store, in storage circuit 81, the information indicating that the state of second stop control circuit 20 is abnormal. Information about abnormality that has been stored in storage circuit 81 may be read out to an outside of vehicle 1 via on-board diagnostics (OBD) interface circuit 82.

Focusing on a fact that diagnostic circuit 30 outputs a signal to in-vehicle network 90, diagnostic circuit 30 can be regarded as an output circuit. Diagnostic circuit 30 and UI circuit 80 can be integrally regarded as an output circuit. Diagnostic circuit 30, first stop control circuit 10, and radio communication circuit 53 can be integrally regarded as an output circuit, or only radio communication circuit 53 can be regarded as an output circuit.

When the state of first stop control circuit 10 is abnormal in step S12 described above (NO in S12), diagnostic circuit 30 transmits the operation signal (the ON signal) to second DC/DC converter 42 and second stop control circuit 20, and starts second stop control circuit 20 (S21). A case where the state of first stop control circuit 10 is abnormal (NO in S12) can be considered to be different from the prescribed state described above.

Diagnostic circuit 30 transmits the stop signal (the OFF signal) to first DC/DC converter 41 and first stop control circuit 10, and stops first stop control circuit 10 (S22). At this time, a power source of a sensor that only outputs detection information to first stop control circuit 10 may be controlled to be in the OFF state. Specifically, diagnostic circuit 30 transmits the stop signal (the OFF signal) to fourth DC/DC converter 44 and second detection circuit 52, and stops second detection circuit 52. This is not applied to a case where second detection circuit 52 is also used for another application.

Diagnostic circuit 30 reports abnormality of first stop control circuit 10 to the driver (S23). As an example, diagnostic circuit 30 causes a lamp provided in UI circuit 80 to flash such that the lamp indicates that the state of first stop control circuit 10 is abnormal.

The processes described above of step S11 to step S23 are repeatedly performed (NO in S24) until vehicle 1 stops (YES in S24).

As described above, according to the first exemplary embodiment, reliability of stop control can be improved by providing second stop control circuit 20 as a backup circuit of first stop control circuit 10. By causing second stop control circuit 20 to intermittently operate when first stop control circuit 10 is in a normal state, power consumption can be suppressed from increasing, and second stop control circuit 20 can be periodically started such that a state is diagnosed. By periodically diagnosing the state, a failure of second stop control circuit 20 during a standby can be made apparent.

When a failure has occurred in first stop control circuit 10, second stop control circuit 20 is started, and first stop control circuit 10 is stopped. By doing this, stop control can be continued, and power consumption can be suppressed from increasing. By stopping second detection circuit 52 that only outputs the detection information to first stop control circuit 10, power consumption can be reduced.

By stopping an operation of second DC/DC converter 42 in addition to second stop control circuit 20 when first stop control circuit 10 is in a normal state, power consumption of second DC/DC converter 42 can be reduced. By stopping an operation of first DC/DC converter 41 in addition to first stop control circuit 10 when first stop control circuit 10 is in an abnormal state, power consumption of first DC/DC converter 41 can be reduced.

As described above, in order to implement the ADAS or automatic driving, it is requested that processing having a large operation amount, such as image processing, be performed. When power is constantly supplied to second stop control circuit 20 that is only used when first stop control circuit 10 is in an abnormal state, as described as second stop control circuit 20, a capacity of power storage 40 is reduced rapidly. In a case where power storage 40 is a traction battery, this significantly causes a decrease in a traveling distance of motor traveling. In contrast, according to the present exemplary embodiment, a decrease in the traveling distance can be suppressed in a state where reliability of the ADAS or automatic driving is secured.

Stated another way, normally, power is intermittently supplied to the second traveling control circuit for backup such that power consumption is suppressed from increasing. When power is supplied, whether the second traveling control circuit is in a normal state or in an abnormal state is confirmed. At least when the second traveling control circuit is in the abnormal state, the output circuit outputs a prescribed output. Therefore, abnormality of the second traveling control circuit can be recognized during a normal operation during which the first traveling control circuit may primarily operate, and reliability of driving support or automatic driving can be enhanced.

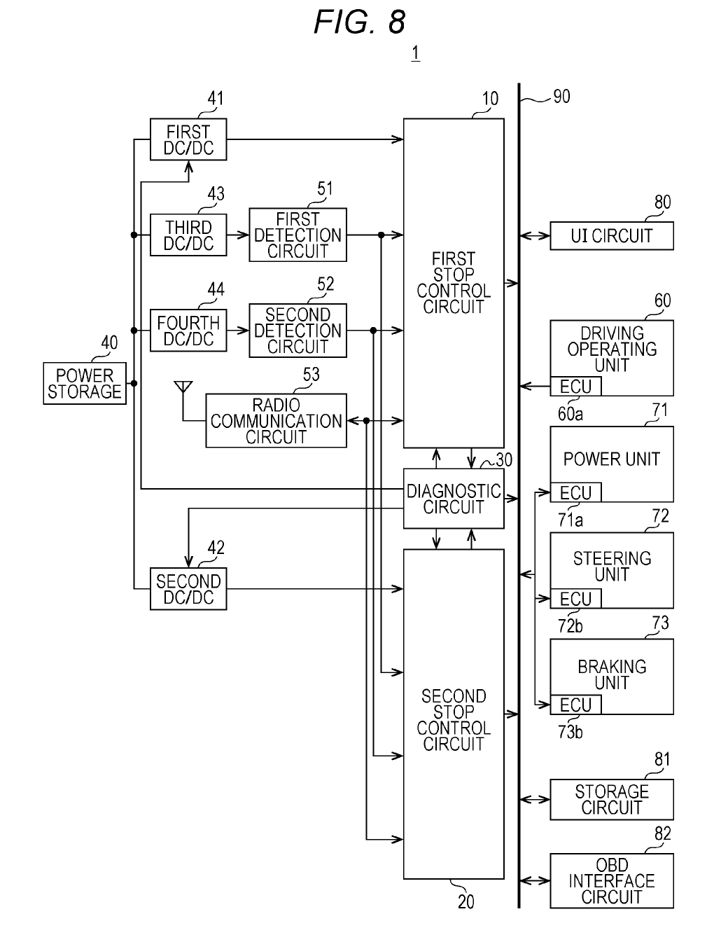

FIG. 8 is a block diagram illustrating a configuration of vehicle 1 according to a second exemplary embodiment of the present disclosure. In the first exemplary embodiment described above, an example has been described in which second stop control circuit 20 has a configuration that is simpler than a configuration of first stop control circuit 10. In the second exemplary embodiment, first stop control circuit 10 and second stop control circuit 20 having the same function as each other are used. First stop control circuit 10 and second stop control circuit 20 may be configured by simply making a single stop control circuit redundant, or first stop control circuit 10 and second stop control circuit 20 that have the same function as each other and have specifications different from each other may be used.

In the second exemplary embodiment, detection information detected by second detection circuit 52 is input to both first stop control circuit 10 and second stop control circuit 20. Second stop control circuit 20 also has a function of monitoring a driver and stopping vehicle 1 in an emergency when an abnormality has occurred in the driver. In addition, second stop control circuit 20 has a function of transmitting a radio signal reporting that the driver has suffered a sudden illness from radio communication circuit 53 to an outside.

According to the second exemplary embodiment, a cost increases in comparison with the first exemplary embodiment because second stop control circuit 20 is not simplified. However, a function of first stop control circuit 10 can be completely backed up when first stop control circuit 10 is in an abnormal state.

The present disclosure has been described above using the exemplary embodiments. It will be understood by those skilled in the art that the exemplary embodiments are merely an example, other exemplary modifications in which components and processes of the exemplary embodiments are variously combined are possible, and the other exemplary modifications still fall within the scope of the present disclosure.

In the first and second exemplary embodiments described above, vehicle 1 is assumed to be an HEV or an EV, but stop control according to the first and second exemplary embodiments is applicable to general engine vehicles. In this case, power storage 40 is an auxiliary battery.

In the first exemplary embodiment described above, an example has been described in which second stop control circuit 20 has a retreating function that is simpler than a retreating function of first stop control circuit 10. Second stop control circuit 20 may be configured to not have the retreating function. In this configuration, second stop control circuit 20 activates a general automatic braking function when there is a risk of collision with an obstacle. In this case, an IC chip equipped with an existing automatic braking function can be diverted.

The techniques described in the exemplary embodiment may also be identified through items described below.

### [Item 1]

A vehicle (1) includes: a power unit (71) that is electrically controlled; a steering unit (72) that is electrically controlled; a braking unit (73) that is electrically controlled; a first traveling control circuit (10) that electrically controls at least one of the power unit (71), the steering unit (72), and the braking unit (73), and performs first traveling control; and a second traveling control circuit (20) that electrically controls at least one of the power unit (71), the steering unit (72), and the braking unit (73), and performs second traveling control. When the first traveling control circuit (10) is in a prescribed state, the first traveling control circuit (10) electrically controls at least one of the power unit (71), the steering unit (72), and the braking unit (73), and performs the first traveling control, power supply to the second traveling control circuit (20) is stopped, and power is supplied to the second traveling control circuit (20) for a second time period at intervals of a first time period. The second time period is shorter than the first time period. The second traveling control circuit (20) that is supplied with the power outputs a state of the second traveling control circuit (20). When the first traveling control circuit (10) is not in the prescribed state, the second traveling control circuit (20) electrically controls at least one of the power unit (71), the steering unit (72), and the braking unit (73), and performs the second traveling control.

The “traveling control” includes at least one of driving support control and automatic driving control. The “prescribed state” may be a normal state.

According to item 1, increase in power consumption can be suppressed while enhancing reliability of traveling control.

### [Item 2]

In the vehicle (1) according to item 1, the first traveling control is first stop control performed on the vehicle (1), and the second traveling control is second stop control performed on the vehicle (1).

According to item 2, increase in power consumption can be suppressed while enhancing reliability of stop control.

### [Item 3]

In the vehicle (1) according to item 2, an absolute value of acceleration (α1) while decelerating in the first stop control is smaller than an absolute value of acceleration (α2) while decelerating in the second stop control.

According to item 3, cost of the second traveling control circuit (20) can be suppressed by simplifying the second stop control than the first stop control.

### [Item 4]

In the vehicle (1) according to item 2, a stop distance (S1) in the first stop control is longer than a stop distance (S2) in the second stop control.

According to item 4, cost of the second traveling control circuit (20) can be suppressed by simplifying the second stop control than the first stop control.

### [Item 5]

In the vehicle (1) according to item 2, a stop position in the first stop control is located apart from a traveling lane (L1) by a first distance (d1), a stop position in the second stop control is located apart from the traveling lane (L1) by a second distance (d2), and the first distance (d1) is longer than the second distance (d2).

According to item 5, cost of the second traveling control circuit (20) can be suppressed by simplifying the second stop control than the first stop control.

### [Item 6]

In the vehicle (1) according to item 5, the first distance (d1) is a distance from a center line (L1c) of the traveling lane (L1) to an end on a side of the center line (L1c) of the vehicle (1), and the second distance (d2) is a distance from the center line (L1c) of the traveling lane (L1) to the end of the vehicle (1).

The “first distance (d1)” may be a distance in a perpendicular direction from the center line (L1c). The “second distance (d2)” may be a distance in a perpendicular direction from the center line (L1c).

According to item 6, cost of the second traveling control circuit (20) can be suppressed by simplifying the second stop control than the first stop control.

### [Item 7]

In the vehicle (1) according to item 1, the first traveling control is traveling control that is performed along a first route that is obtained based on positional information of the vehicle (1), and the second traveling control is traveling control that is performed along a second route that is obtained without using the positional information of the vehicle (1).

According to item 7, cost of the second traveling control circuit (20) can be suppressed by simplifying the second stop control than the first stop control.

### [Item 8]

The vehicle (1) according to any one of items 1 to 7 further includes a diagnostic unit (30) that monitors at least a state of the first traveling control circuit (10), and that performs control, when the first traveling control circuit (10) is in the prescribed state, to stop the power supply to the second traveling control circuit (20) and to supply the power to the second traveling control circuit (20) for the second time period at the intervals of the first time period.

The “prescribed state” may be a normal state.

According to item 8, reliability of traveling control can be enhanced by including the diagnostic unit (30).

### [Item 9]

In the vehicle (1) according to item 8, the second traveling control circuit (20) that is supplied with the power outputs a state of the second traveling control circuit (20) to the diagnostic unit (30).

According to item 9, the diagnostic unit (30) can grasp a state of the second traveling control circuit (20).

### [Item 10]

In the vehicle (1) according to item 1, a scale of the first traveling control circuit (10) is larger than a scale of the second traveling control circuit (20).

The “scale” can be expressed by a number of transistors or an area of a semiconductor chip (in a case where the same microfabrication technique is applied).

According to item 10, cost of the second traveling control circuit (20) can be suppressed.

### [Item 1]

The vehicle (1) according to any one of items 1 to 10 further includes: a first detector (51) that detects a situation outside the vehicle (1); and a second detector (52) that detects a situation inside the vehicle (1). At least one of a detection result of the first detector (51) and a detection result of the second detector (52) is input to the first traveling control circuit (10), and at least one of the detection result of the first detector (51) and the detection result of the second detector (52) is input to the second traveling control circuit (20).

The “situation inside the vehicle” may be a situation of the driver.

According to item 11, the second traveling control circuit (20) can perform a traveling control equivalent to the first traveling control circuit (10).

### [Item 12]

The vehicle (1) according to any one of items 1 to 10 further includes: a first detector (51) that detects a situation outside the vehicle (1); and a second detector (52) that detects a situation inside the vehicle (1). A detection result of the first detector (51) and a detection result of the second detector (52) are input to the first traveling control circuit (10), and the detection result of the first detector (51) is input to the second traveling control circuit (20).

The “situation inside the vehicle” may be a situation of the driver.

According to item 12, cost of the second traveling control circuit (20) can be suppressed.

### [Item 13]

A traveling controller is to be installed in a vehicle (1). The traveling controller includes: a power unit (71) that is electrically controlled; a steering unit (72) that is electrically controlled; a braking unit (73) that is electrically controlled; a first traveling control circuit (10) that electrically controls at least one of the power unit (71), the steering unit (72), and the braking unit (73), and performs first traveling control; and a second traveling control circuit (20) that electrically controls at least one of the power unit (71), the steering unit (72), and the braking unit (73), and performs second traveling control. When the first traveling control circuit (10) is in a prescribed state, the first traveling control circuit (10) electrically controls at least one of the power unit (71), the steering unit (72), and the braking unit (73), and performs the first traveling control, power supply to the second traveling control circuit (20) is stopped, and power is supplied to the second traveling control circuit (20) for a second time period at intervals of a first time period. The second time period is shorter than the first time period. The second traveling control circuit (20) that is supplied with the power outputs a state of the second traveling control circuit (20). When the first traveling control circuit (10) is not in the prescribed state, the second traveling control circuit (20) electrically controls at least one of the power unit (71), the steering unit (72), and the braking unit (73), and performs the second traveling control.

The “traveling control” includes at least one of driving support control and automatic driving control. The “prescribed state” may be a normal state.

According to item 13, increase in power consumption can be suppressed while enhancing reliability of traveling control.

### [Item 14]

In the traveling controller according to item 13, the first traveling control is first stop control performed on the vehicle (1), and the second traveling control is second stop control performed on the vehicle (1).

According to item 14, increase in power consumption can be suppressed while enhancing reliability of stop control.

### [Item 15]

In the traveling controller according to item 14, an absolute value of acceleration (α1) while decelerating in the first stop control is smaller than an absolute value of acceleration (α2) while decelerating in the second stop control.

According to item 15, cost of the second traveling control circuit (20) can be suppressed by simplifying the second stop control than the first stop control.

### [Item 16]

In the traveling controller according to item 14, a stop distance (S1) in the first stop control is longer than a stop distance (S2) in the second stop control.

According to item 16, cost of the second traveling control circuit (20) can be suppressed by simplifying the second stop control than the first stop control.

### [Item 17]

In the traveling controller according to item 14, a stop position in the first stop control is located apart from a traveling lane (L1) by a first distance (d1), a stop position in the second stop control is located apart from the traveling lane (L1) by a second distance (d2), and the first distance (d1) is longer than the second distance (d2).

According to item 17, cost of the second traveling control circuit (20) can be suppressed by simplifying the second stop control than the first stop control.

### [Item 18]

In the traveling controller according to item 17, the first distance (d1) is a distance from a center line (L1c) of the traveling lane (L1) to an end on a side of the center line (L1c) of the vehicle (1), and the second distance (d2) is a distance from the center line (L1c) of the traveling lane (L1) to the end of the vehicle (1).

The “first distance (d1)” may be a distance in a perpendicular direction from the center line (L1c). The “second distance (d2)” may be a distance in a perpendicular direction from the center line (L1c).

According to item 18, cost of the second traveling control circuit (20) can be suppressed by simplifying the second stop control than the first stop control.

### [Item 19]

In the traveling controller according to item 13, the first traveling control is traveling control that is performed along a first route that is obtained based on positional information of the vehicle (1), and the second traveling control is traveling control that is performed along a second route that is obtained without using the positional information of the vehicle (1).

According to item 19, cost of the second traveling control circuit (20) can be suppressed by simplifying the second stop control than the first stop control.

### [Item 20]

The traveling controller according to any one of items 13 to 19 further includes a diagnostic unit (30) that monitors at least a state of the first traveling control circuit (10), and that performs control, when the first traveling control circuit (10) is in the prescribed state, to stop the power supply to the second traveling control circuit (20) and to supply the power to the second traveling control circuit (20) for the second time period at the intervals of the first time period.

The “prescribed state” may be a normal state.

According to item 20, reliability of traveling control can be enhanced by including the diagnostic unit (30).

### [Item 21]

In the traveling controller according to item 20, the second traveling control circuit (20) that is supplied with the power outputs a state of the second traveling control circuit (20) to the diagnostic unit (30).

According to item 21, the diagnostic unit (30) can grasp a state of the second traveling control circuit (20).

### [Item 22]

In the traveling controller according to item 13, a scale of the first traveling control circuit (10) is larger than a scale of the second traveling control circuit (20).

The “scale” can be expressed by a number of transistors or an area of a semiconductor chip (in a case where the same microfabrication technique is applied).

According to item 22, cost of the second traveling control circuit (20) can be suppressed.

### [Item 23]

The traveling controller according to any one of items 13 to 22 further includes: a first detector (51) that detects a situation outside the vehicle (1); and a second detector (52) that detects a situation inside the vehicle (1). At least one of a detection result of the first detector (51) and a detection result of the second detector (52) is input to the first traveling control circuit (10), and at least one of the detection result of the first detector (51) and the detection result of the second detector (52) is input to the second traveling control circuit (20).

The “situation inside the vehicle” may be a situation of the driver.

According to item 23, the second traveling control circuit (20) can perform a traveling control equivalent to the first traveling control circuit (10).

### [Item 24]

The traveling controller according to any one of items 13 to 22 further includes: a first detector (51) that detects a situation outside the vehicle (1); and a second detector (52) that detects a situation inside the vehicle (1). A detection result of the first detector (51) and a detection result of the second detector (52) are input to the first traveling control circuit (10), and the detection result of the first detector (51) is input to the second traveling control circuit (20).

The “situation inside the vehicle” may be a situation of the driver.

According to item 24, cost of the second traveling control circuit (20) can be suppressed.

The present disclosure is useful as a vehicle having a driving support function or an automatic driving function, a traveling controller, and the like.

What is claimed is:

1. A vehicle comprising:
a power unit that is electrically controlled;
a steering unit that is electrically controlled;
a braking unit that is electrically controlled;
a first traveling control circuit that electrically controls at least one of the power unit, the steering unit, and the braking unit, and performs first traveling control;
a second traveling control circuit that electrically controls at least one of the power unit, the steering unit, and the braking unit, and performs second traveling control; and
an output circuit,
wherein when the first traveling control circuit is in a prescribed state,
the first traveling control circuit electrically controls at least one of the power unit, the steering unit, and the braking unit, and performs the first traveling control,
power supply to the second traveling control circuit is stopped,
power is supplied to the second traveling control circuit for a second time period at intervals of a first time period, the second time period being shorter than the first time period, and
when the second traveling control circuit that is supplied with the power is not in a normal state, the output circuit outputs a prescribed output, and
when the first traveling control circuit is not in the prescribed state,
the second traveling control circuit electrically controls at least one of the power unit, the steering unit, and the braking unit, and performs the second traveling control.

2. The vehicle according to claim 1, wherein a state where the first traveling control circuit is in the prescribed state is a state where the first traveling control circuit is in a normal state.

3. The vehicle according to claim 1, wherein when the second traveling control circuit that is supplied with the power is in the normal state, the output circuit does not output the prescribed output.

4. The vehicle according to claim 1, wherein
the output circuit includes a display circuit that is recognized by a passenger of the vehicle, and
when the second traveling control circuit that is supplied with the power is not in the normal state, the display circuit displays information indicating that the second traveling control circuit is not in the normal state.

5. The vehicle according to claim 1, wherein
the output circuit includes a radio communication circuit that performs radio communication with an outside, and
when the second traveling control circuit that is supplied with the power is not in the normal state, the radio communication circuit transmits information to the outside via the radio communication, the information indicating that the second traveling control circuit is not in the normal state.

6. The vehicle according to claim 5, wherein when the second traveling control circuit that is supplied with the power is not in the normal state, the radio communication circuit transmits, to the outside via the radio communication, information indicating that the second traveling control circuit is not in the normal state.

7. The vehicle according to claim 1, further comprising a storage circuit,
wherein when the second traveling control circuit that is supplied with the power is not in the normal state, the output circuit stores, in the storage circuit, information indicating that the second traveling control circuit is not in the normal state.

8. The vehicle according to claim 1, wherein
the first traveling control is first stop control performed on the vehicle, and
the second traveling control is second stop control performed on the vehicle.

9. The vehicle according to claim 8, wherein an absolute value of acceleration while decelerating in the first stop control is smaller than an absolute value of acceleration while decelerating in the second stop control.

10. The vehicle according to claim 8, wherein a stop distance in the first stop control is longer than a stop distance in the second stop control.

11. The vehicle according to claim 8, wherein
a stop position in the first stop control is located apart from a traveling lane by a first distance,
a stop position in the second stop control is located apart from the traveling lane by a second distance, and
the first distance is longer than the second distance.

12. The vehicle according to claim 11, wherein
the first distance is a distance from a center line of the traveling lane to an end on a side of the center line of the vehicle, and
the second distance is a distance from the center line of the traveling lane to the end of the vehicle.

13. The vehicle according to claim 1, wherein
the first traveling control is traveling control that is performed along a first route that is obtained based on positional information of the vehicle, and
the second traveling control is traveling control that is performed along a second route that is obtained without using the positional information of the vehicle.

14. The vehicle according to claim 1, further comprising a diagnostic unit that monitors at least a state of the first traveling control circuit, and that performs control, when the first traveling control circuit is in the prescribed state, to stop the power supply to the second traveling control circuit and to supply the power to the second traveling control circuit for the second time period at the intervals of the first time period.

15. The vehicle according to claim 14, wherein the second traveling control circuit that is supplied with the power outputs a state of the second traveling control circuit to the diagnostic unit.

16. The vehicle according to claim 1, wherein a scale of the first traveling control circuit is larger than a scale of the second traveling control circuit.

17. The vehicle according to claim 1, further comprising:
a first detector that detects a situation outside the vehicle; and
a second detector that detects a situation inside the vehicle,
wherein at least one of a detection result of the first detector and a detection result of the second detector is input to the first traveling control circuit, and
at least one of the detection result of the first detector and the detection result of the second detector is input to the second traveling control circuit.

18. The vehicle according to claim 1, further comprising:
a first detector that detects a situation outside the vehicle; and
a second detector that detects a situation inside the vehicle,
wherein a detection result of the first detector and a detection result of the second detector are input to the first traveling control circuit, and
the detection result of the first detector is input to the second traveling control circuit.

19. A traveling controller that is installed in a vehicle that includes:
a power unit that is electrically controlled;
a steering unit that is electrically controlled; and
a braking unit that is electrically controlled, the traveling controller comprising:
a first traveling control circuit that electrically controls at least one of the power unit, the steering unit, and the braking unit, and performs first traveling control;
a second traveling control circuit that electrically controls at least one of the power unit, the steering unit, and the braking unit, and performs second traveling control; and
an output circuit,
wherein when the first traveling control circuit is in a prescribed state,
the first traveling control circuit electrically controls at least one of the power unit, the steering unit, and the braking unit, and performs the first traveling control,
power supply to the second traveling control circuit is stopped,
power is supplied to the second traveling control circuit for a second time period at intervals of a first time period, the second time period being shorter than the first time period, and
when the second traveling control circuit that is supplied with the power is not in a normal state, the output circuit outputs a prescribed output, and
when the first traveling control circuit is not in the prescribed state,
the second traveling control circuit electrically controls at least one of the power unit, the steering unit, and the braking unit, and performs the second traveling control.
